(19) United States
(12) Patent Application Publication
(10) Pub. No.: US 2018/0213759 A1
(43) Pub. Date: Aug. 2, 2018

(54) FISHING BAIT HOLDERS

(71) Applicant: Benjamin Carl Bustamante, Greeley, CO (US)

(72) Inventor: Benjamin Carl Bustamante, Greeley, CO (US)

(21) Appl. No.: 15/421,753

(22) Filed: Feb. 1, 2017

(51) Int. Cl. A01K 91/04; A01K 93/00; A01K 91/10; A01K 95/00; A01K 83/06

(52) U.S. Cl. CPC A01K 91/04; A01K 93/00; A01K 83/06; A01K 95/00; A01K 91/10

(57) ABSTRACT

A variety of fishing lure assembles are disclosed which can hold a live worm on a skewer or in a clamp. A powerbait and a standard lure embodiment are disclosed, wherein all embodiments can enable the hook to be several inches away from the bait. When the fish bites the bait and swims away, he drags the invention down to the hook and gets hooked. Many options are provided the fisherman to either lock the invention fast to the fishing line or provide for the sliding action.

### CROSS REFERENCE APPLICATIONS

This application is a non-provisional application claiming the benefits of provisional application Ser. No. 29/564,961 filed May 17, 2016.

### FIELD OF INVENTION

The present invention relates to securing a worm (real or artificial) in close proximity to a fish hook but not directly on the shaft of the fish hook.

### BACKGROUND OF THE INVENTION

FIGS. 1 and 2 show the traditional method and apparatus used to thread a worm W onto a hook 1. First the worm W is threaded down its length over a needle 2 as shown in FIG. 1. The fisherman holds a handle 3 that secures the needle 2. The needle 2 has a distal hole 4 that receives the tip T of the hook 1 as shown by the arrow in FIG. 1. The hook 1 is tied to the string 5.

In FIG. 2 the fisherman has pushed the worm W off the needle 2 up and over the hook 1 so as to position the worm W over a shank of the hook and up over the string 5. How much of the worm W that remains on the hook 1 is determined by the fisherman. The design idea is to get the fish to bite the worm W, and the hook tip T cuts into a segment of the fish's mouth.

A problem with this design is that the fish may detect the hook 1 and decide not to bite the worm W. What is needed in the art is a system that keeps the worm separate from the worm so that the fish is not afraid to bite the worm. What is further needed is a system that pulls the hook into the fish's mouth as the fish swims away with the worm. The present invention offers several systems that thread the worm onto the string while keeping the hook away from the worm.

### SUMMARY OF THE INVENTION

The primary aspect of the present invention is to provide a worm threader that is separate from the hook.

Another aspect of the present invention is to provide a threader on the fishing line that can be pushed through a worm lengthwise while allowing a chosen length of the fishing line to be separate from the hook so that a fish biting the worm will cause the worm to slide down to the hook, thus hooking the fish when the fish swims away with the worm.

Another aspect of the present invention is to provide an embodiment that clamps the worm and optionally slides down the fishing line to force the hook into the fish's mouth as the fish swims away.

Another aspect of the present invention is to provide for an adjustable length of fish line between the worm threader/clamp and the hook.

Another aspect of the present invention is to provide a lock means functioning to lock the worm threader/clamp anywhere along the fish line.

Another aspect of the present invention is to provide enough fish line to allow a fisherman to sew his hook multiple times through the worm that is on either the threader or the clamp.

Another aspect of the invention is to provide an attachment of a lure on the clamp so as to camouflage the clamp.

Another aspect of the invention is to provide a float on the fish line that is either attached to the clamp or detached from the clamp.

Another aspect of the present invention is to provide a first mode that allows the fish line and the hook to slide through the clamp and the float and a second mode that locks the fish line and hook a set distance from the float.

Another aspect of the present invention is to provide a power bait nut to be attached to the float in a first mode or be locked separate from the float in a second mode.

Another aspect of the present invention is to provide a sliding mount for the power bait nut to allow the nut to slide down the fish line and hook the fish.

Another aspect of the present invention is to provide an attachment that secures a float to an anchor for a prior art lure.

Another aspect of the present invention is to provide a surface float that suspends either a worm clamp or a worm clamp and float a chosen depth underwater.

Another aspect of the present invention is to provide a heavy sinker weight in combination with a worm clamp and float combination to allow fishing a chosen distance off the bottom with a worm.

Another aspect of the present invention is to provide a multi-purpose fixture embodiment to allow a lure to be attached below it and a float above it and provide for the line to have a hook at its distal end.

Other aspects of this invention will appear from the following description and appended claims, reference being made to the accompanying drawings forming a part of this specification wherein like reference characters designate corresponding parts in the several views.

### BRIEF DESCRIPTION OF THE DRAWINGS

FIG. 1 (prior art) is a side perspective view of a worm threader ready to thread the worm over the hook.

FIG. 2 (prior art) is the same view as FIG. 1 with the worm threaded over and beyond the hook.

FIG. 2A is a top perspective view of a slidable worm threader.

FIG. 2B is a side elevation view of the slidable worm threader of FIG. 2A.

FIG. 2C is a rear plan view of the slidable worm threader of FIG. 2A.

FIG. 2D is a front plan view of the slidable worm threader of FIG. 2A.

FIG. 2E is an exploded view of the slidable worm threader of FIG. 2A.

FIG. 2F is a top perspective view of the slidable worm threader of the FIG. 2A in use.

FIG. 3A is an exploded view of a worm clamper.

FIG. 3B is a bottom perspective view of the worm clamper in use.

FIG. 3C is a bottom perspective view of the worm clamper in use in an alternate manner.

FIG. 3D is a bottom perspective view of the worm clamper in use with an artificial lure attached.

FIG. 3E is a bottom perspective view of the worm clamper attached to small float.

FIG. 3F is a bottom perspective view of the worm clamper attached to a large float.

FIG. 3G is a bottom perspective view of the worm clamper in use with the float separated from the worm clamper.

FIG. 4A is a bottom perspective view of the worm clamper connected directly to a float.

FIG. 4B is a bottom perspective view of the worm clamper connected directly to a float and shown in use.

FIG. 4C is the same view as FIG. 4B using a large float.

FIG. 5A is an exploded view of a power bait nut connected to a float.

FIG. 5B is a bottom perspective view of the FIG. 5A embodiment in use.

FIG. 5C is an exploded view of the power bait nut connected down line from a float.

FIG. 5D is a bottom perspective view of the FIG. 5C embodiment in use.

FIG. 5E is a side elevation view of a power bait nut in use hooking a fish.

FIG. 6A is an exploded view of a lure fixture embodiment connected to a float.

FIG. 6B is a bottom perspective view of the FIG. 6A embodiment in use.

FIG. 7A is a side elevation view of the FIG. 3B embodiment in use on the bottom without any floats.

FIG. 7B is a side elevation view of the FIG. 4B embodiment in use on the bottom without any floats.

FIG. 7C is a side elevation view of the FIG. 3B embodiment in use with a bottom sinker with the worm clamp attached to a float.

FIG. 7D is the same view as FIG. 7C with the float separated from the worm clamp.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION OF THE DRAWINGS

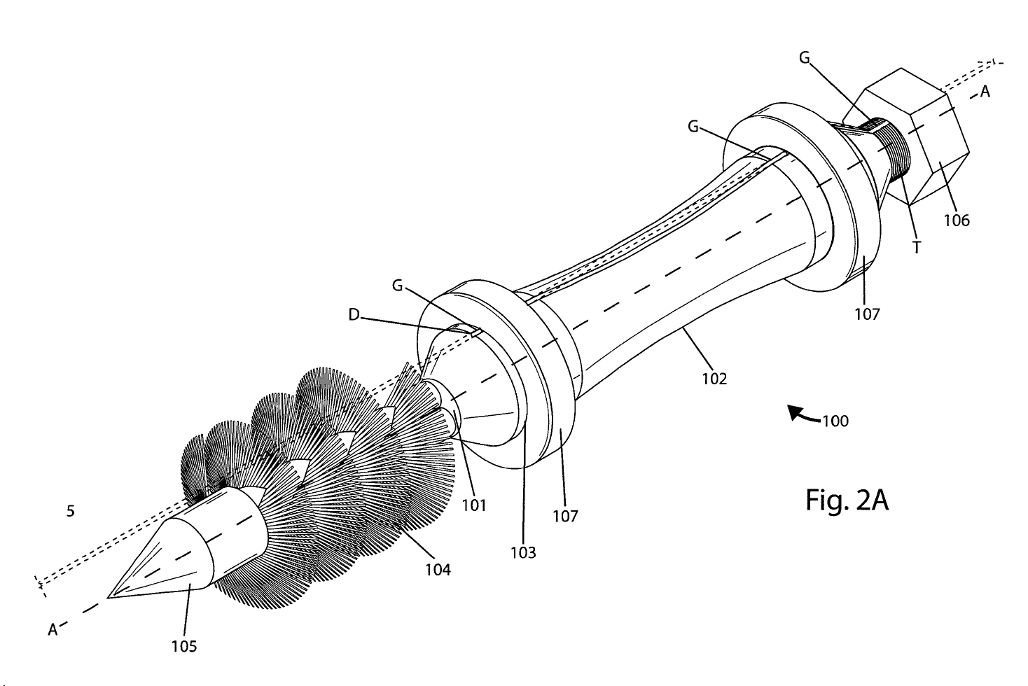

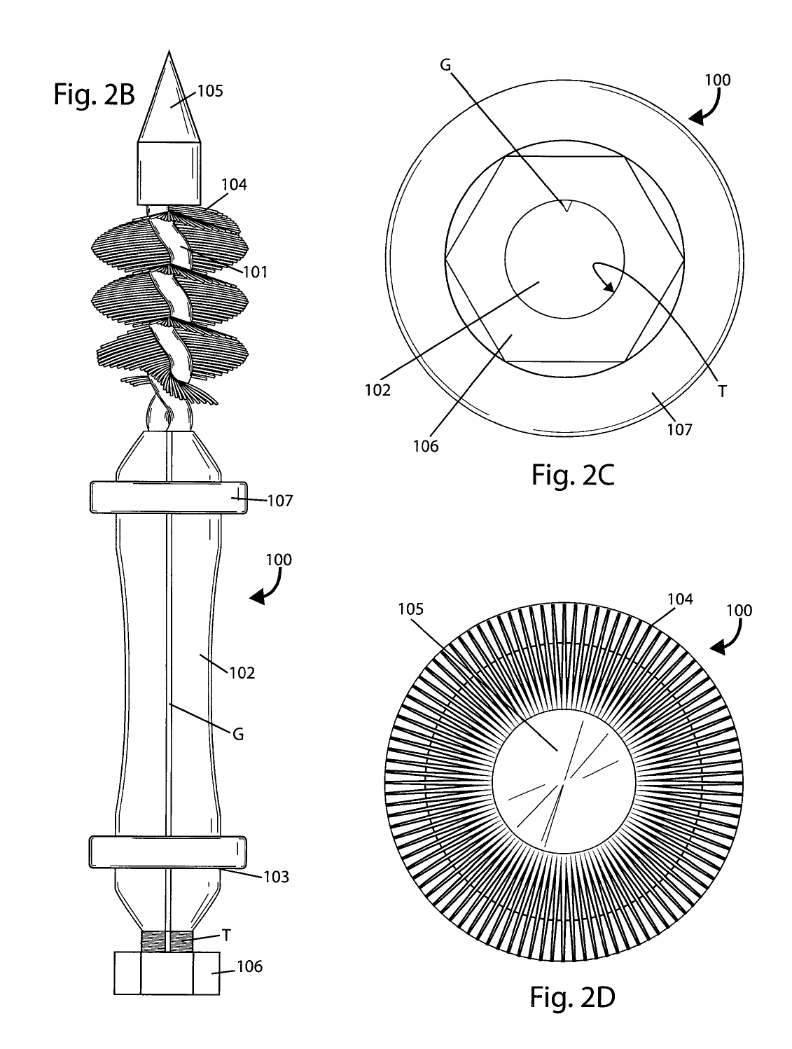

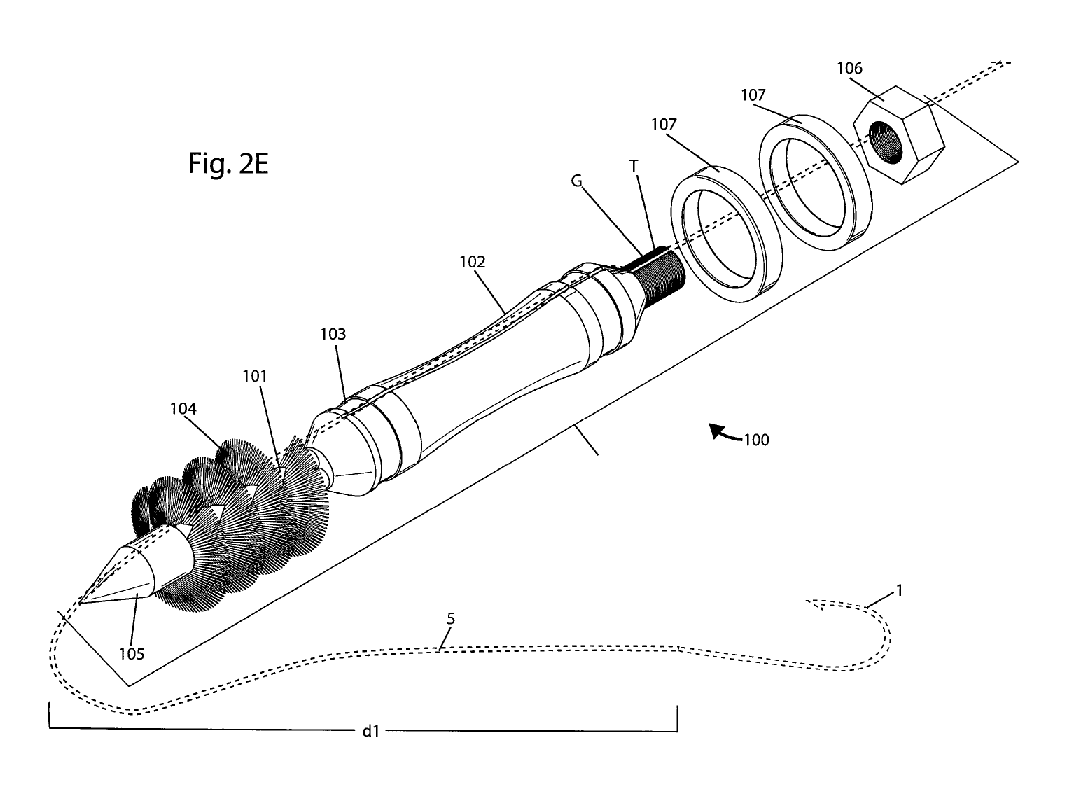

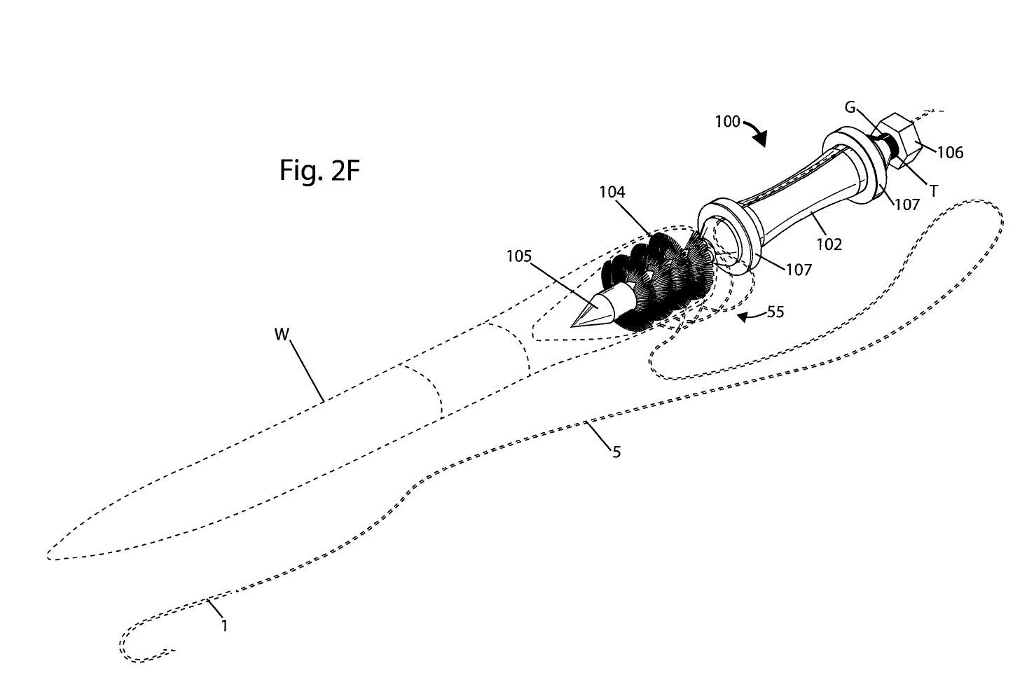

Referring next to FIGS. 2A, 2B, 2C, 2D, 2E, 2F a worm brush 100 is shown to have a longitudinal axis A. The fish line is labeled 5 and the hook 1. A brush shaft 101 extends along axis A from the bait body 102. Optionally a brush nut 103 may be threaded onto the bait body 102 to allow affixing a variety of brush shafts.

The brush shaft 101 secures a spiraled brush 104. A tip 105 of the brush shaft 101 is sharp so as to easily be thrust up through a longitudinal axis of a worm W as seen in FIG. 2F. A groove G runs along the bait body 102 and through the threads T to enable the line 5 to pass under the line nut 106 and out the distal end D of the bait body 102. In operation when the line nut 106 is loose, the bait body 102 can slide along the fish line 5. When the line nut 106 is tightened, the bait body 102 is locked on the fish line 5. An O-ring 107 helps keep the fish line 5 in the grove G. The distance dl is set by the fisherman nominally from an inch to several feet.

Referring to FIG. 2F the fisherman has mounted the worm W on the brush shaft 101 by piercing an end of the worm W with tip 105 and then pushing the worm W over the brush 104. The fisherman has sewn the worm W with the hook 1 at area 55 in his chosen manner. Many loops of line 5 around the worm W will impede the sliding capability of the bait body down the line 5 when the fish swims away. But the fisherman can choose to keep distance dl short and plan that the fish will swallow both the worm W and the hook 1 in one bite. In this scenario the bait body 102 does not need to slide down the line 5.

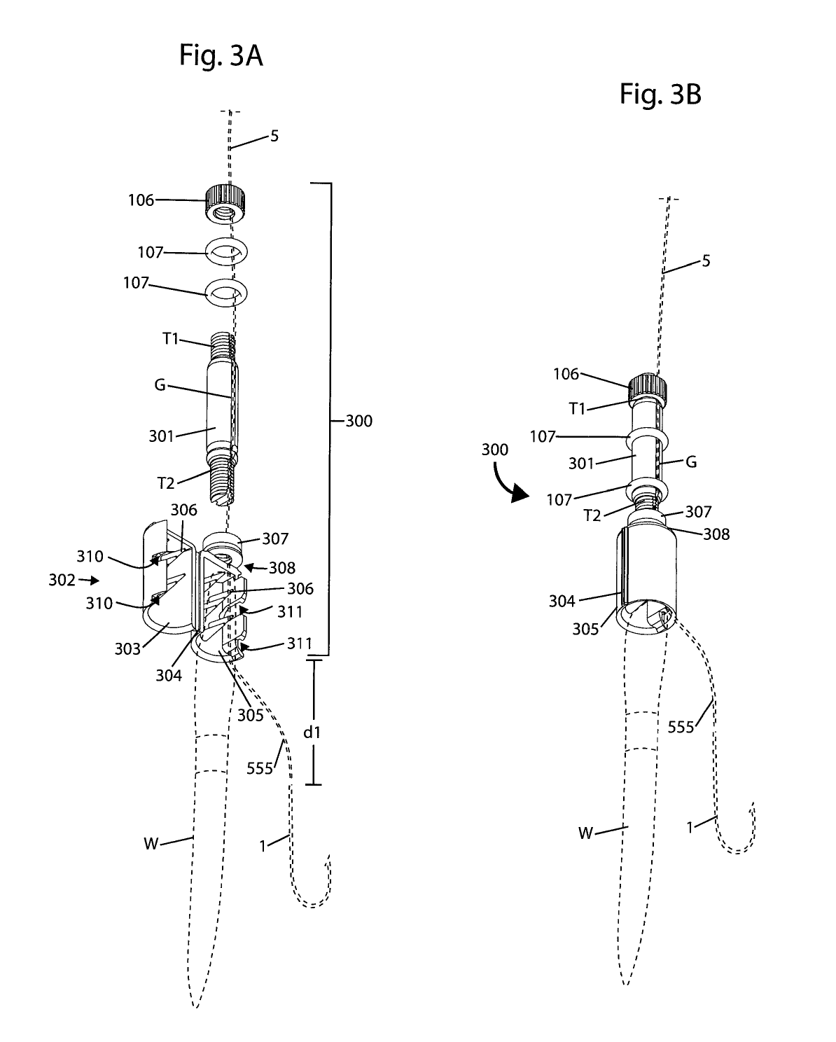

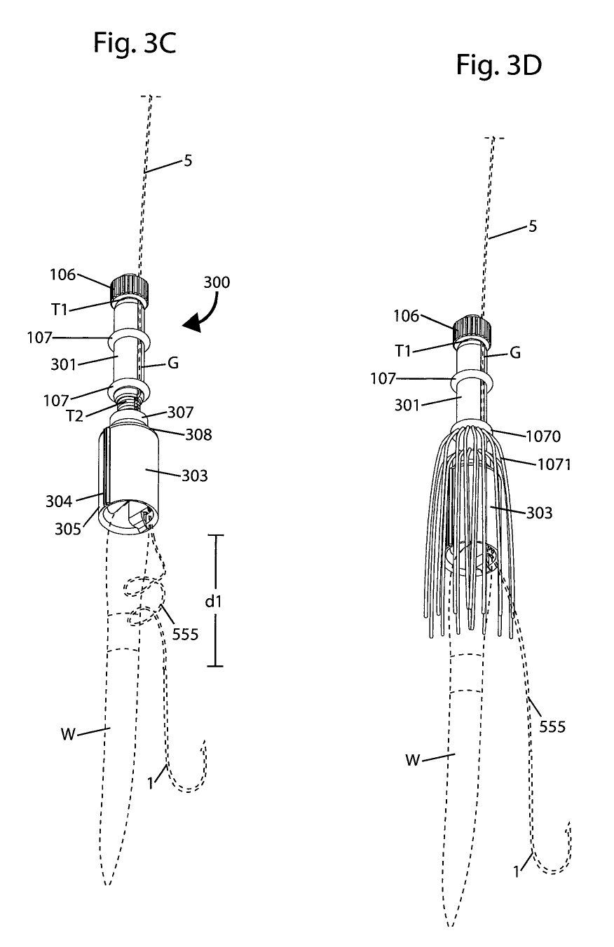

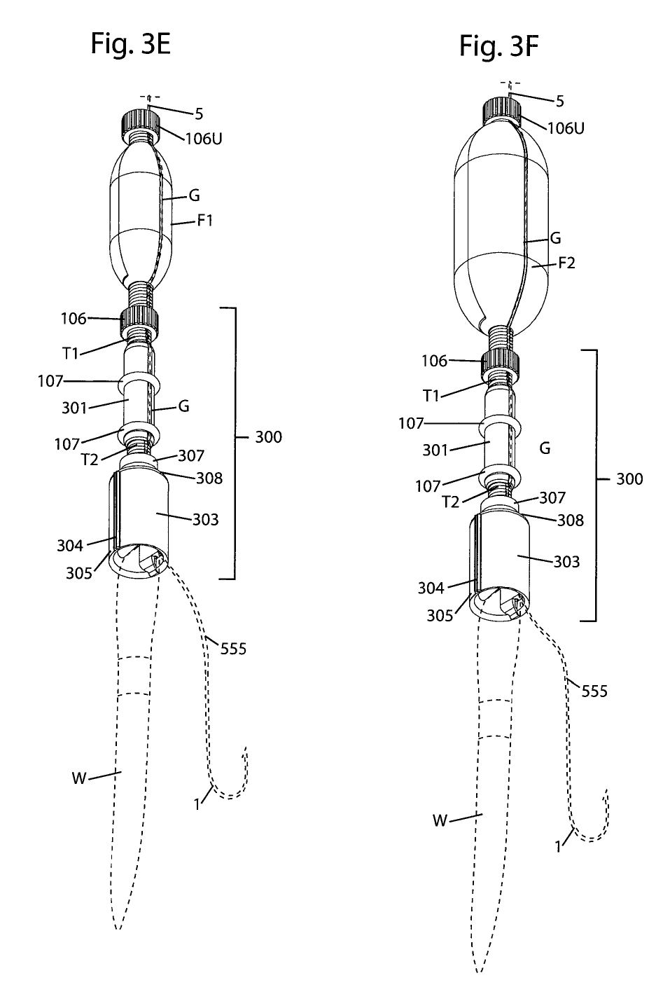

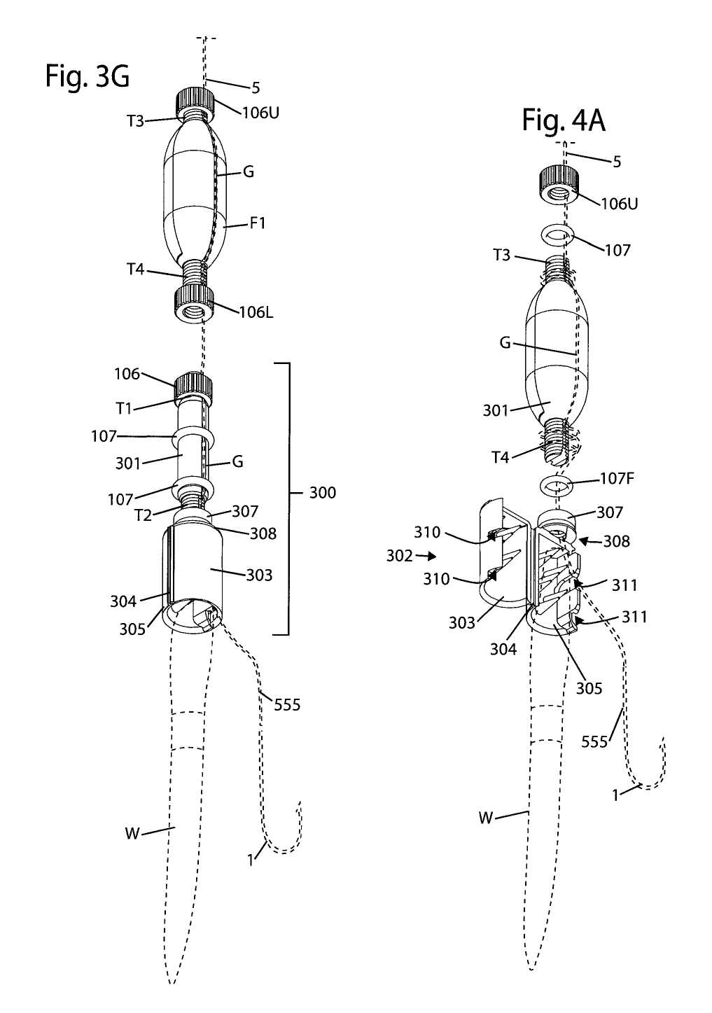

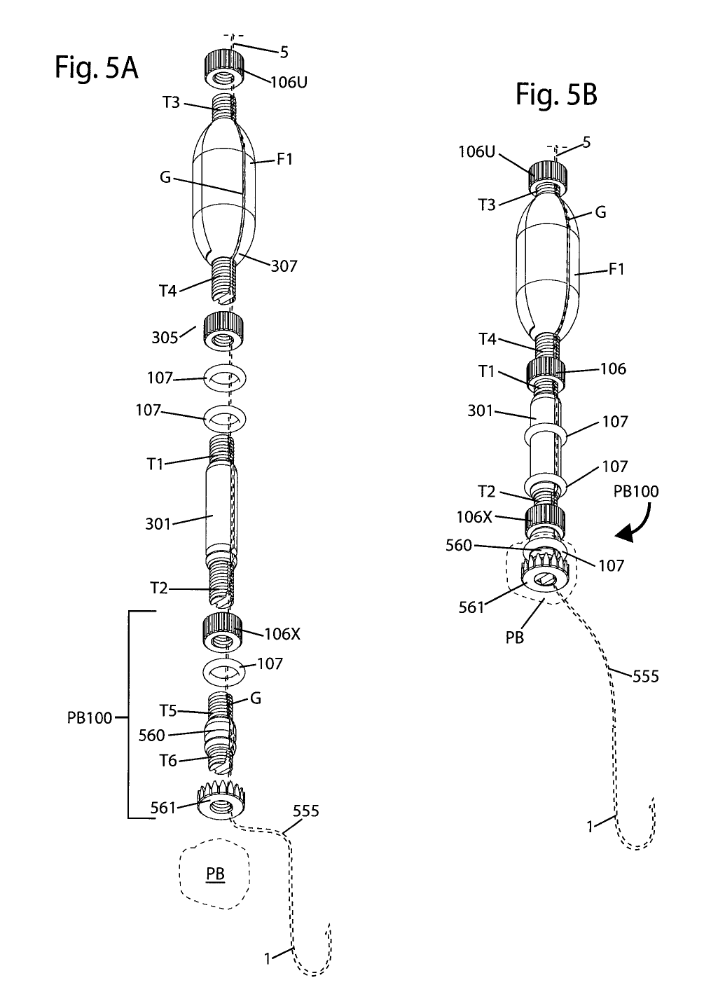

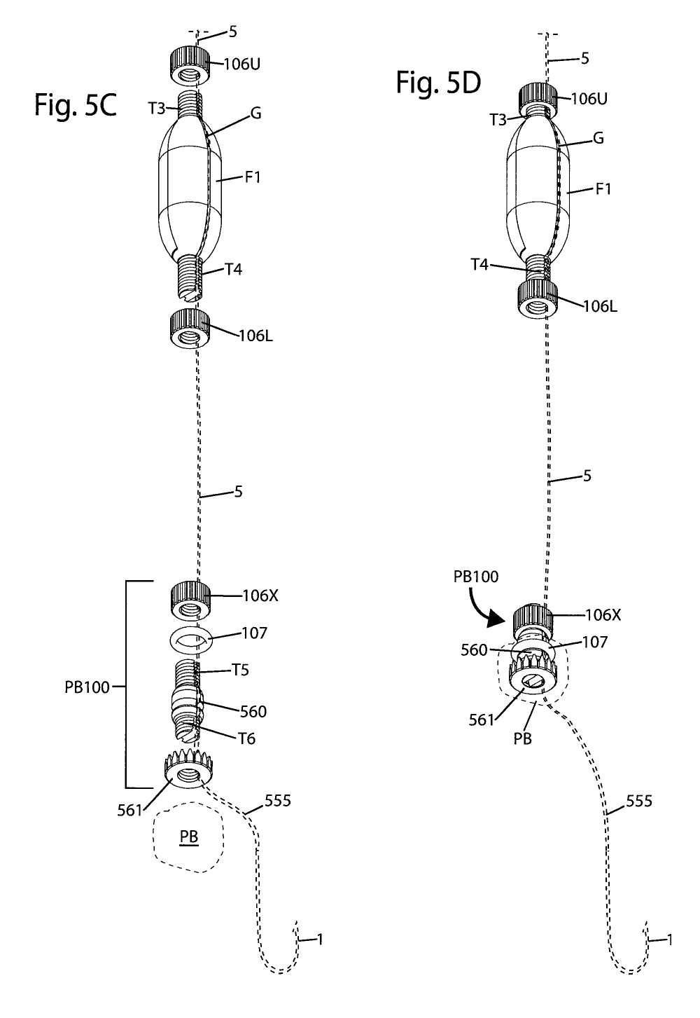

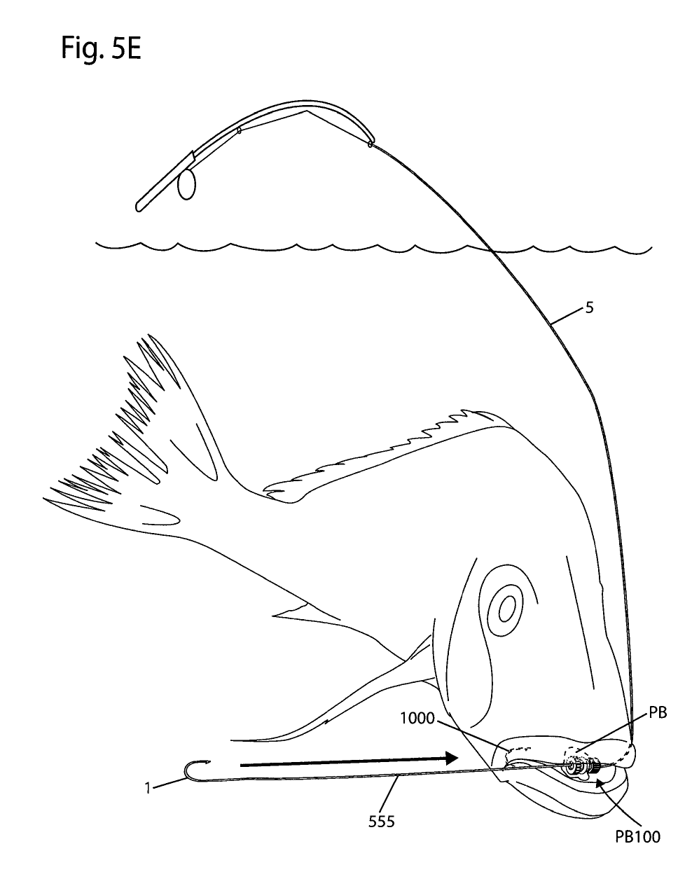

Referring to the FIGS. 3A, 3B, 3C a worm clamp 300 comprises a line body 301 that has a groove G to receive a line 5. The line 5 rests in the groove G in threaded upper end T1 and threaded lower end T2. O-rings 107 hold the line 5 in groove G. A lock nut 106 passes over the line 5 on upper end T1. Generally the lock nut 106 is set to allow the line body to slide down the line 5 as the fish bites the worm W and swims away. This action sets hook 1 in the fish as depicted in FIG. 5E.

The worm clamp compartment 302 comprises a top 303, a hinge 304 and a bottom 305. There are interlocking teeth 306 in both the top 303 and bottom 305. A nut is attached to the bottom 305 so as to enable the bottom 305 to be threaded onto bottom end T2 of the line body 301.

As shown in FIG. 3A generally the fisherman will thread the line 5 to exit the nut 307 at its bottom 308. Thus, the line segment 555 is set at a chosen distance dl so as to keep the hook 1 away from the worm W.

Referring next to FIG. 3C the fisherman has threaded the line 5 through the top 303 and bottom 305 so as to exit the worm clamp 300 at the distal end 309. He then has sewn the worm W at point 310 on the worm's body. The line 5 will slide in groove G and between top 303 and bottom 305 unless the fisherman chooses to lock the nut 106 against the 5 at the bottom of threaded end T1. In this mode he would shorten dl to place the hook next to the worm W so the fish bites the hook 1 with the worm W.

Referring next to FIG. 3D the lower O-ring has been replaced with an artificial lure O-ring 1070 having a skirt 1071 that camouflages clamp top 303 and bottom 305.

Referring next to FIG. 3E a float F1 has been attached to line body 301 using the common nut 106. Lower threaded end T4 screws into nut 106. Upper threaded end T3 has the continuous groove G and is capped with nut 106 U. The assembly F1 and worm clamp 300 can slide on line 5. FIG. 3F shows an identical setup with a larger float F2. In either embodiment the line body 301 can be eliminated. Then the top 303 and bottom 305 clamps assembly can be threaded directly to the float F1, F2.

Referring next to FIG. 3G the float F1 is mounted on line 5 separate from the worm clamp 300. An upper nut 106U and a lower nut 106L secure the line 5 in the groove G or float F1. When the fish hits worm W the float F1 will remain stationary on line 5.

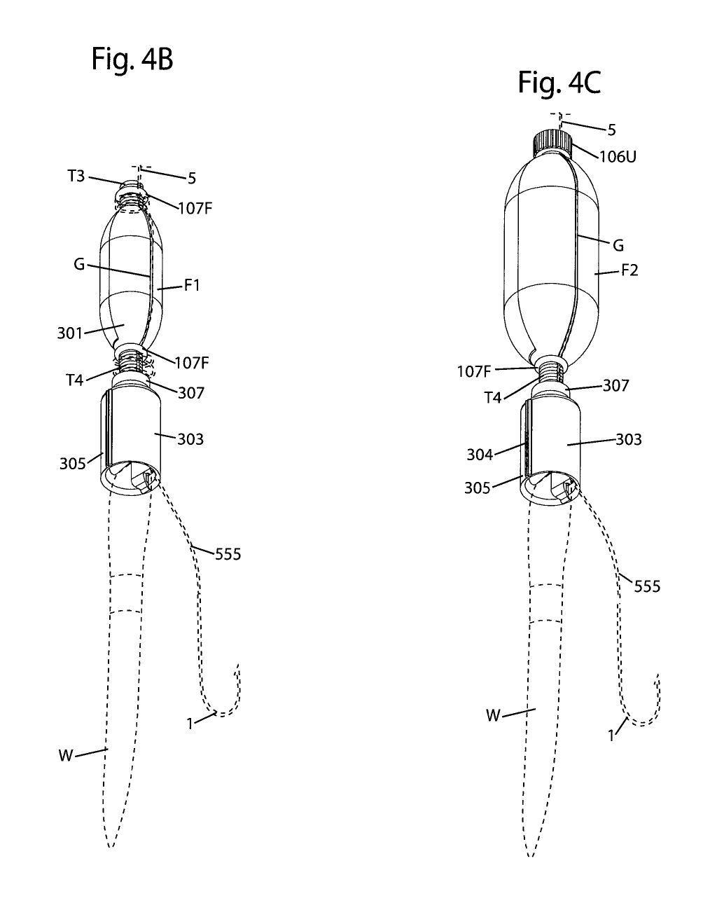

Referring next to FIGS. 4A, 4B, 4C the line body 301 has been eliminated. The bottom 305 with its nut 307 threads directly onto lower threaded end T4 of float F1. Upper threaded end T3 can have either a nut 106U or just an O-ring 107 to secure line 5 in groove G. As shown the line 5 is wrapped around upper threaded end T3 and lower threaded end T4 to lock the assembly float F1 and bottom 305 fast onto line 5. Thus, the hook 1 must be set to be swallowed with the worm W as shown. The fisherman could remove the line wraps on T3, T4 so the assembly floats F1 and bottom 305 slide on line 5. The line could exit under O-ring 107F. The line segment 555 could be made several feet long.

In FIG. 4B the fully assembled combination of the float F1 and the bottom 305 is shown. The fisherman has wound his line 5 around threaded end T4 of float F1. In FIG. 4C the fisherman has chosen a larger float F2 and threaded his line 5 under the lower O-ring 107F to allow the assembly of the float F2 and bottom 305 to slide on line 5. The upper nut 106U would not be locked against line 5.

Referring next to FIGS. 5A, 5B, 5C, 5D, 5E a variety of power bait embodiments are shown where the fisherman has chosen to use power bait rather than a worm. A power bait lure PB100 comprises a shaft 560 with an upper threaded end T5 and a lower threaded end T6. The same continuous groove G is formed in shaft 560. A common nut 106X joins threaded end T2 to threaded end T5. The powerbait nut threads onto lower threaded end T6. The power bait PB is squeezed onto the power bait nut 561 as shown in FIG. 5B. The sliding assembly of the float F1 and the line body 301 connected to the power bait lure PB100 slides along line 5 to allow the hook 1 to rest far away from the power bait lure PB100 as shown.

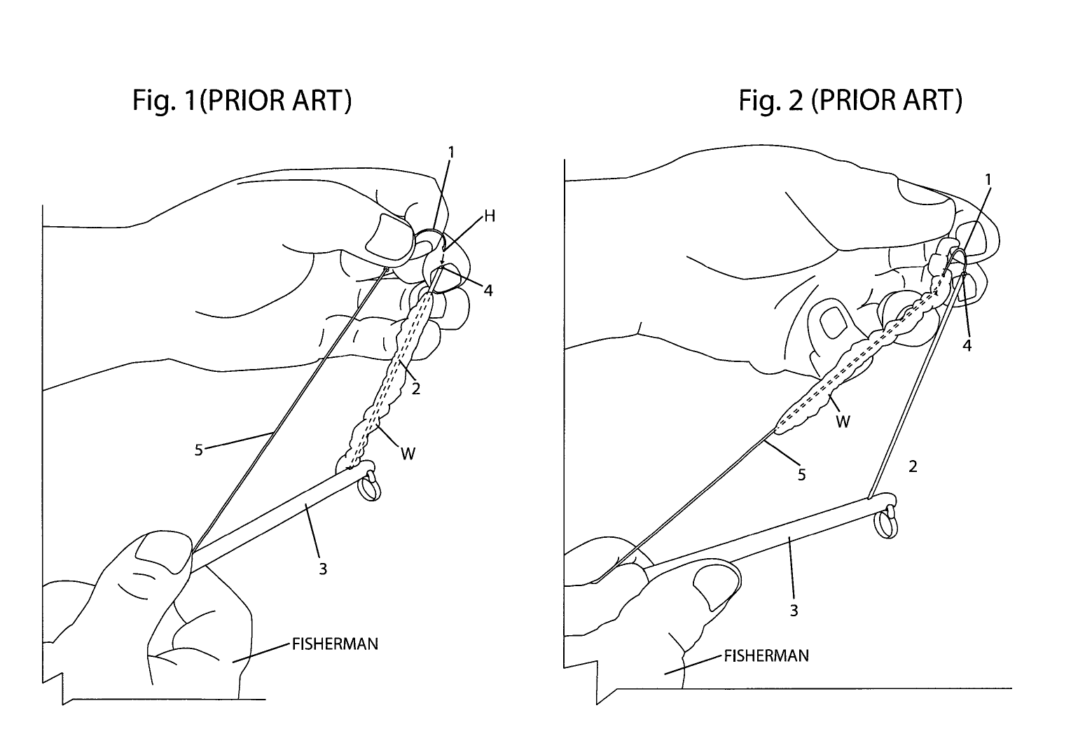

Referring next to FIGS. 5C, 5D the fisherman has separated the power bait's lure PB100 from the float FIG. 1. In FIG. 5C he has threaded the line 5 to come out under O-ring 107. In FIG. 5D he threaded the line 5 all the way through the power bait's lure PB100.

Referring next to FIG. 5E the power bait lure PB100 is attached to line 5 without any float. The fish F has bitten the power bait lure PB100, as the fish swims away he slides the power bait lure PB100 down the line segment 555, and arrow OUCH shows how the hook 1 snags the fish shown by dotted hook 1000.

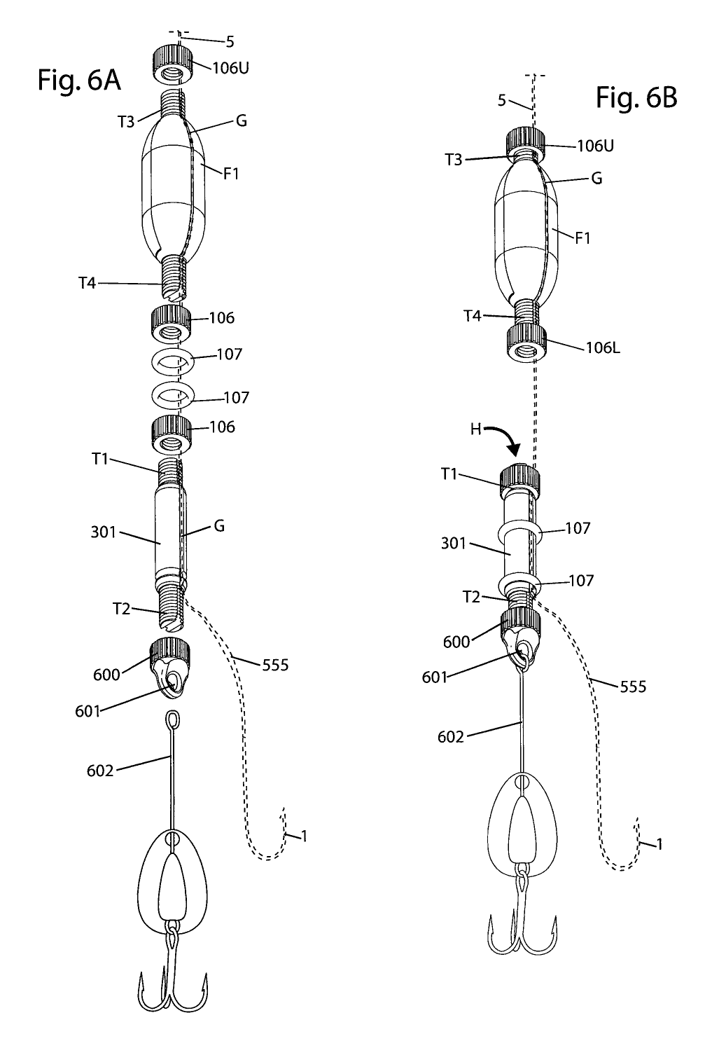

Referring next to FIGS. 6A, 6B line body 301 can also serve as a support for a prior art lure 602. Lower threaded end T2 receives a nut anchor 600 which has an anchor hole 601 to secure the lure 602. In FIG. 6B the float F1 is separate from the line body 301. When using the lure 602, the hook 1 is secured in hole H since it is not in use.

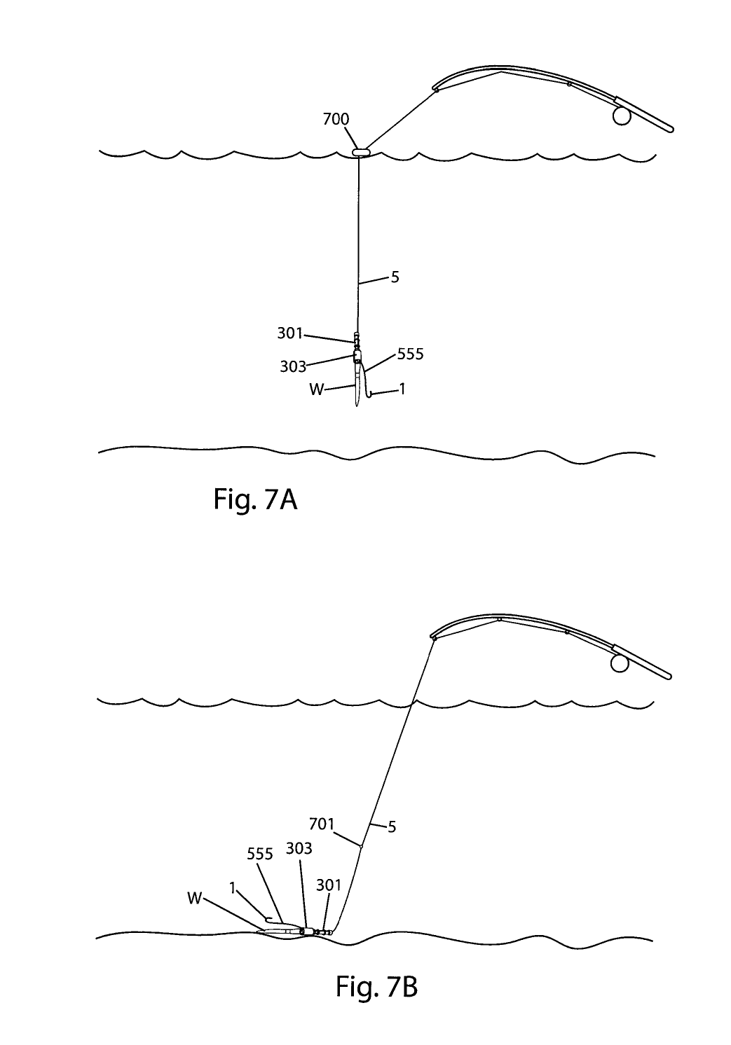

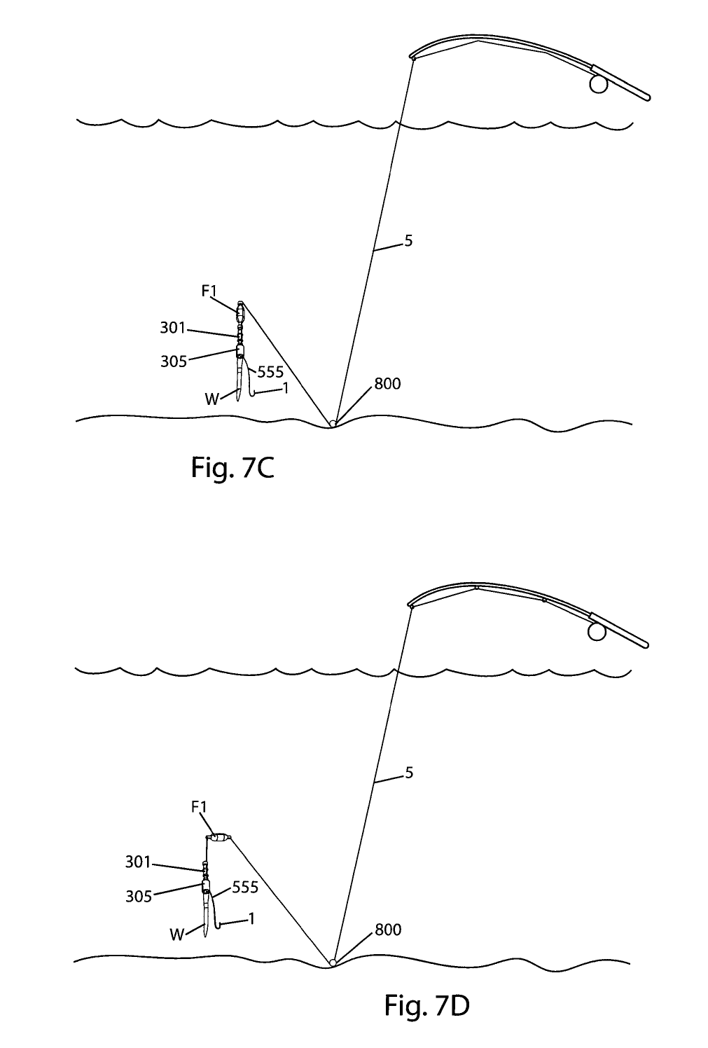

Referring next to FIG. 7A the embodiment shown in FIG. 3B is shown suspended from a surface float 700. In FIG. 7B the embodiment shown in FIG. 4B is shown lying on the bottom. A small sinker weight 701 has been added on the line 5.

Referring next to FIG. 7C the embodiment shown in FIG. 4B is shown floating up from a bottom sinker 800 that is on line 5. In FIG. 7D the embodiment shown in FIG. 3G is shown floating up from a bottom sinker 800 that is on line 5.

Although the present invention has been described with reference to the disclosed embodiments, numerous modifications and variations can be made and still the result will come within the scope of the invention. No limitation with respect to the specific embodiments disclosed herein is intended or should be inferred. Each apparatus embodiment described herein has numerous equivalents.

I claim:

1. A fishing line comprises:
a line body comprising a longitudinal groove to receive a fish line;
said line body having a top threaded end and a bottom threaded end, each threaded end having a groove conforming to the groove in the line body;
a top nut to encircle the fish line and thread onto the top threaded end to the fish line to slide through the groove(s) in a loose mode and to lock the fish to the line body in a tightened mode;
a worm clamp having a connector nut to threaded onto the bottom threaded end;
said worm clamp having a top connected to a bottom;
a plurality of teeth mounted in the worm clamp;
an O-ring functioning to secure the fish line in the groove on the bottom threaded end;
wherein the fish line can slide through the groove(s) with the O-ring on the bottom threaded end and with the worm clamp threaded onto the bottom threaded end; and
the fish line can extend a chosen distance away from the bottom threaded end with a hook attached at a distal end of the fish line.

2. The fishing lure of claim 1, wherein the top has a hinged connection to the bottom.

3. The fishing lure of claim 2, wherein the teeth are mounted in the top and the bottom to extend into a hollow between the top and the bottom.

4. The fishing line of claim 1, wherein the connector nut is fastened on the bottom of the worm clamp.

5. The fishing line of claim 1, wherein the line body supports a camouflaging artificial lure to hide the worm clamp.

6. The fishing lure of claim 1, wherein the line body further comprises a float attached to the top threaded end.

7. The fishing lure of claim 6, wherein the float further comprises a groove which allows the fishing line to slide therethrough.

8. The fishing line of claim 7, wherein the float further comprises a lower nut which is shared with the line body and a top nut which is threaded onto the fishing line.

9. A fishing lure comprising:
a worm clamp having a top connected to a bottom and teeth in a hollow between the top and the bottom;
a connector nut on the worm clamp;
a float threaded into the connector nut; and
said float having a longitudinal groove to allow a fishing line to slide therethrough while a chosen length of fishing line extends from the float with a hook on a distal end of the fishing line.

10. The fishing lure of claim 9, wherein the top has a hinged connection to the bottom, and the teeth extend from the top and the bottom into the hollow.

11. The fishing lure of claim 10, wherein the nut is connected to the bottom.

12. The fishing lure of claim 9, wherein the float further comprises a bottom threaded end with a groove and an O-ring to allow the fishing line to slide through the groove(s).

13. The fishing lure of claim 12, wherein the bottom threaded end is threaded onto the connector nut.

14. The fishing lure of claim 13 further comprising a bottom weight fastened to the line upstream from the float so as to enable the bottom weight to rest on a bottom of a body of water while the float rises a chosen height above the bottom.

15. The fishing lure of claim 1 further comprising a float fastened upstream from the line body, said float having a longitudinal groove to receive the fish line and an upper and a bottom threaded end each with a groove and a nut.

16. A power bait lure comprising:
a line body having an upper and a bottom threaded end and a longitudinal groove travelling entirely down a side;
an upper nut that can be threaded on a fishing line and then onto the upper threaded end to allow the fishing line to slide in the groove;
an O-ring on the line body to allow the fishing line to slide under it and support a chosen length of fishing line away from the line body with a hook on a distal end of the fishing line; and
a lower nut threaded onto the bottom threaded end;
said lower nut having a plurality of peripheral teeth facing upstream; and
wherein when a fish bites the powerbait lure with powerbait squeezed onto the powerbait lure, the fish can slide the powerbait lure downstream into the hook.

17. The powerbait lure of claim 16 further comprising a float assembly threaded onto the upper nut, said float assembly having a longitudinal groove all along a side to enable the fishing line to slide therethrough.

18. The powerbait lure of claim 17, wherein the float further comprises an upper and a lower threaded end, and the upper threaded end has a nut to either lock the fishing line when tightened or release the fishing line when loosened.
